(19) United States
(12) Patent Application Publication
(10) Pub. No.: US 2023/0267468 A1
(43) Pub. Date: Aug. 24, 2023

(54) UNSUPERVISED CLUSTERED EXPLANATION-BASED FEATURE SELECTION USING TRANSFER LEARNING FOR LOW FRAUD SCENARIO

(71) Applicant: Actimize LTD., Ra'anana (IL)

(72) Inventors: Sunny THOLAR, Pune (IN); Amir SHACHAR, Haifa (IL)

(21) Appl. No.: 17/678,443

(22) Filed: Feb. 23, 2022

(51) Int. Cl. G06Q 20/40

(52) U.S. Cl. CPC G06Q 20/4016

(57) ABSTRACT

A machine learning (ML) system configured to detect fraud in tenant data systems. The system includes a processor and a computer readable medium operably coupled thereto, the computer readable medium comprising a plurality of instructions stored in association therewith that are accessible to, and executable by, the processor, to perform ML modeling operations which include receiving a first data set, determining that the first data set meets or exceeds a low fraud tenant threshold, segmenting the first tenant data system based on the first data set, determining first features of a first ML model, determining a first explanation of a first feature importance of each of the first features, comparing the first tenant data system to a second tenant data system based on at least the first explanation and a second explanation, ranking at least the first features and the second features, and performing a feature selection.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to detecting fraud using artificial intelligence (AI) systems, such as fraud that may occur in transaction data sets for financial institutions, and more specifically to a system and method for generating and training machine learning (ML) models using transfer learning for feature selection during low fraud scenarios.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

Banks and other financial institutions may utilize ML models and engines in order to detect instances of fraud and implement anti-fraud solutions. However, certain financial institutions may have instances of low fraud counts within their financial records and transaction data sets. A low fraud count in a transaction data set, as compared to standard and/or legitimate transactions in the transaction data set, may create problems during robust ML model creation by not having a sufficiently diverse training data set. This limits data extractions and/or feature learning. When possible, a simple linear regression model may be created in place of boosted trees models. However, these ML model may fail to identify true fraud and may increase incidences of false positives.

These mistakes by ML models may have significant effects on financial institutions. For example, such mistakes may result in millions of dollars of loss to the financial institutions if an ML model is not properly trained and tuned for accurate decision-making and fraud detection. In the instances of low fraud scenarios and training data, features may be filtered based on a subject matter expert's understanding of these features' performances and importance in an ML model. The model is then re-trained based on the subset of selected features by the subject matter expert. However, this is a manual approach and, due to the manual approach, it may not be possible to cover all the fraud detection and/or prevention scenarios, as well as select the best features based on learning from different tenant financial institutions (e.g., different financial institutions utilizing a fraud detection system). Thus, there is a need to create a hybrid model using feature selection based on features dynamically and intelligently selected after transfer learning from different tenants and their data sets.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified block diagram of a networked environment suitable for implementing the processes described herein according to an embodiment.

FIG. 2 is a simplified block diagram of a transfer learning system that may perform feature selection between a selected and target financial institution according to some embodiments.

FIG. 3 is a simplified diagram of weighted explainable scores used for transfer learning according to some embodiments.

FIG. 4 is a simplified diagram of feature ranking in a transfer learning system according to some embodiments.

FIG. 5 is a simplified diagram of an exemplary flowchart for a transfer learning system for feature selection in unsupervised machine learning models according to some embodiments.

FIG. 6 is a simplified diagram of a computing device according to some embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

In order to provide for feature selection of features for an ML model usable during low fraud count scenarios, a hybrid model may be trained and generated as discussed herein. ML models may be built on different tenants of a fraud detection and/or ML model training system, such as different financial institutions. Thereafter, SHapley Additive exPlanations (SHAP) may be run on transactions for each model in order to provide an ML model explanation. SHAP provides a contribution of each feature to each model and allows for converting local interpretations to global interpretations. Further, SHAP allows for generating statistics regarding the performance of each feature for each ML model using “SHAPley” or “Shapley” values, where the higher the value is in the ML model explanation, the higher the contribution that the feature has in the final prediction by the model. Thus, features may be ranked based on the ML model explanation and Shapley values.

These operations may then be repeated for each tenant. The median of Shapley values may be taken across different tenants using transfer learning. An automated script may be run to find the subset of features for an ML model based on ranking of the features, which assists in identifying more fraudulent transactions or activities during a small number of alerts, occurrences, and/or observations (e.g., a low fraud scenario). Therefore, the hybrid approach assists in identifying a robust subset of features for ML models, which work best among various tenants during low fraud scenarios. This approach assists in solving the problem of low fraud scenarios and non-diverse training data sets, which helps to achieve better performance of ML models and AI systems for low fraud scenarios.

The embodiments described herein provide methods, computer program products, and computer database systems for an ML system for fraud detection in transaction data sets that is generated using feature selection from transfer learning. A financial institution or other service provider system may therefore include a fraud detection system that may access different transaction data sets and detect fraud using trained ML models having feature selection from transfer learning. The system may analyze transaction data sets from multiple financial institutions and may perform feature selection using weighted explainable scores between segments of the transaction data sets. The weighted explainable scores may be generated using similarity scores between the financial institutions and Shapley values. The system may then perform a feature ranking using transfer learning, which may be used for feature selection and ML model generation. Once the ML models are generated as described herein, ML models may be deployed for intelligent fraud detection systems.

According to some embodiments, in an ML system accessible by a plurality of separate and distinct organizations, ML algorithms, features, and models are provided for identifying, predicting, and classifying fraudulent transactions using transfer learning, thereby optimizing feature selection and ML model training for fraudulent transaction detection, and providing faster and more precise predictive analysis by ML systems.

### Example Environment

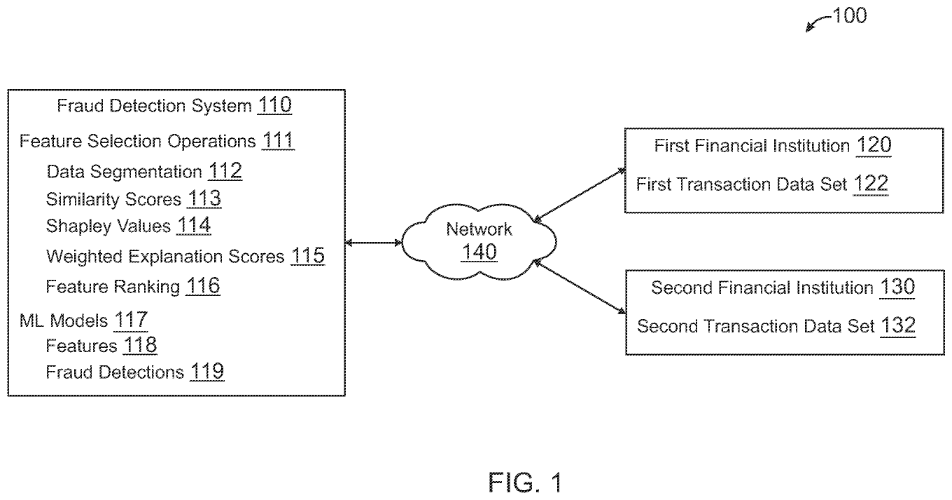

The system and methods of the present disclosure can include, incorporate, or operate in conjunction with or in the environment of an ML engine, model, and intelligent fraud detection system, which may include an ML or other AI computing architecture that is trained using transfer learning for feature ranking and selection. FIG. 1 is a block diagram of a networked environment 100 suitable for implementing the processes described herein according to an embodiment. As shown, environment 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, ML, neural network (NN), and other AI architectures have been developed to improve predictive analysis and classifications by systems in a manner similar to human decision-making, which increases efficiency and speed in performing predictive analysis of transaction data sets. One or more devices and/or servers may be operated and/or maintained by the same or different entities.

FIG. 1 illustrates a block diagram of an example environment 100 according to some embodiments. Environment 100 may include a fraud detection system 110, a first financial institution 120, and a second financial institution 130 that interact to provide intelligent detection of fraud detection, prevention, and/or other risk analysis operations through training of one or more ML models through transfer learning for feature ranking and selection. In other embodiments, environment 100 may not have all of the components listed and/or may have other elements instead of, or in addition to, those listed above. In some embodiments, the environment 100 is an environment in which fraud detection may be performed through an ML or other AI system. As illustrated in FIG. 1, fraud detection system 110 might interact via a network 140 with first financial institution 120 and second financial institution 130, which generates, provides, and outputs feature selection and/or training for ML models.

Fraud detection system 110 may be utilized in order to determine an ML model for fraud detection in low fraud scenarios using transaction data sets provided by first financial institution 120 and second financial institution 130. Fraud detection system 110 may first perform feature selection operations 111 on one or more of first transaction data set 121 from first financial institution 120 and/or second transaction data set 131 from second financial institution 130 for feature selection and training of ML models 117. First financial institution 120 and second financial institution 130 may each correspond to a single entity, such as a bank or other financial institution, or may correspond to multiple different entities that provide segments and/or portions of first transaction data set 121 and second transaction data set 131, respectively. Additionally, first financial institution 120 and second financial institution 130 may, in some embodiments, correspond to different entities having different data sets for training and modeling of an ML model for fraud detection in low fraud scenarios. Prior to generating one or more of ML models 117 by feature selection operations 111, fraud detection system 110 may perform data pre-processing on first transaction data set 121 and second transaction data set 131, which may include data extraction and cleaning, fraud enrichment, data segmentation 112, and identification of low fraud scenarios in data segments. This may include steps such as data cleaning to remove or update one or more columns and/or features, sampling of training and testing data sets, normalizing to reduce the mean and provide missing value imputation, and/or feature engineering of features in the data sets that may be used for model training.

Thereafter, feature selection operations 111 generate and determine one or more initial ML models on the training data for each financial institution, segmented data set, and the like using an ML algorithm and technique. This may correspond to an unsupervised ML algorithm that includes unlabeled data and/or classifications or a supervised ML algorithm with labeled data and/or classifications (e.g., gradient boosting (e.g., XGBoost), which is applied to the pre-processed training data from first transaction data set 121 and second transaction data set 131 separately. Additionally, multiple different types of ML algorithms may be used to generate different ML models, which may utilize a Python anomaly detection package such as Python Outlier Detection (PyOD). Unsupervised models may include principal component analysis (PCA), k-means clustering, more advanced deep learning algorithms (e.g., variational auto encoders), and the like. Each initial ML model may be trained and selected based on the data set and scenario. These models are generated to provide risk or fraud predictions and/or scores on the data set at stake (e.g., first transaction data set 121 and/or second transaction data set 131) for ML modeling for anomalous transaction and/or fraud detection. Similarity scores 113 may be generated between different financial institutions, such as first financial institution 120 and second financial institution 130 based on first transaction data set 121 and second transaction data set 131, respectively. Thereafter, model evaluation may be performed by applying SHAP algorithms and model explanation to generate Shapley values of the features from the models initially trained from one or more of first transaction data set 121 and one or more of second transaction data set 131. This provides Shapley values 114 for those data sets and/or data segmentations of data sets selected for ML model generation.

After generating of similarity scores 113 and Shapley values 114, these scores are used to create weighted explanation scores 115 for comparison of features between the ML models and determination of feature ranking 116. This provides transfer learning by training models with features after ranking and selecting the feature for ML modeling. Prior to feature ranking, selection, and ML modeling, weighted explanation scores 115 are used for transfer learning by comparing financial institutions and obtaining feature ranking 116 using an automated script for forward feature selection. Thereafter, ML models 117 may be trained for features 118 in order to output fraud detections 119 for financial institutions during low fraud scenarios for training and testing data, such as where first transaction data set 121 and/or second transaction data set 131 may be segmented and have data that includes low counts of fraud. The ML algorithm may correspond to an unsupervised ML algorithm. In order to understand the models and verify whether the set of features adds value to the fraud detection ML model, the forward feature selection may run logistic regression models and use detection date (DR) and/or value detection rate (VDR) to identify features 118 for ML models 117. Thereafter, one or more hybrid ML models from ML models 117 may be deployed with intelligent fraud detection system 110 to perform fraud detections 119.

One or more client devices and/or servers may execute a web-based client that accesses a web-based application for fraud detection system 110, or may utilize a rich client, such as a dedicated resident application, to access fraud detection system 110. These client devices may utilize one or more application programming interfaces (APIs) to access and interface with fraud detection system 110 in order to schedule, review, and execute ML modeling using the operations discussed herein. Interfacing with fraud detection system 110 may be provided through an application and may be based on data stored by a database, fraud detection system 110, first financial institution 120, and/or second financial institution 130. The client devices might communicate with fraud detection system 110 using TCP/IP and, at a higher network level, use other common Internet protocols to communicate, such as hypertext transfer protocol (HTTP or HTTPS for secure versions of HTTP), file transfer protocol (FTP), wireless application protocol (WAP), etc. Communication between the client devices and fraud detection system 110 may occur over network 140 using a network interface component of the client devices and a network interface component of fraud detection system 110. In an example where HTTP/HTTPS is used, the client devices might include an HTTP/HTTPS client commonly referred to as a “browser” for sending and receiving HTTP//HTTPS messages to and from an HTTP//HTTPS server, such as fraud detection system 110 via the network interface component. Similarly, fraud detection system 110 may host an online platform accessible over network 140 that communicates information to and receives information from the client devices. Such an HTTP/HTTPS server might be implemented as the sole network interface between the client devices and fraud detection system 110, but other techniques might be used as well or instead. In some implementations, the interface between the client devices and fraud detection system 110 includes load sharing functionality. As discussed above, embodiments are suitable for use with the Internet, which refers to a specific global internet of networks. However, it should be understood that other networks can be used instead of the Internet, such as an intranet, an extranet, a virtual private network (VPN), a non-TCP/IP based network, any LAN or WAN, or the like.

The client devices may utilize network 140 to communicate with fraud detection system 110, first financial institution 120, and/or second financial institution 130, which is any network or combination of networks of devices that communicate with one another. For example, the network can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global inter network of networks often referred to as the Internet. However, it should be understood that the networks that the present embodiments might use are not so limited, although TCP/IP is a frequently implemented protocol.

According to one embodiment, fraud detection system 110 is configured to provide webpages, forms, applications, data, and media content to the client devices and/or to receive data from the client devices. In some embodiments, fraud detection system 110 may be provided or implemented in a cloud environment, which may be accessible through one or more APIs with or without a correspond graphical user interface (GUI) output. Fraud detection system 110 further provides security mechanisms to keep data secure. Additionally, the term “server” is meant to include a computer system, including processing hardware and process space(s), and an associated storage system and database application (e.g., object-oriented data base management system (OODBMS) or relational database management system (RDBMS)). It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

In some embodiments, first financial institution 120 and second financial institution 130, shown in FIG. 1, executes processing logic with processing components to provide data used for feature selection operations 111 and ML model 117 generation. For example, in one embodiment, first financial institution 120 and second financial institution 130 includes application servers configured to implement and execute software applications as well as provide related data, code, forms, webpages, platform components or restrictions, and other information associated with data sets for ML model determination, and to store to, and retrieve from, a database system related data, objects, and web page content associated with fraud detection in transaction data sets. For example, fraud detection system 110 may implement various functions of processing logic and processing components, and the processing space for executing system processes, such as running applications for ML modeling and/or fraud detection. First financial institution 120 and second financial institution 130 may be accessible over network 140. Thus, fraud detection system 110 may send and receive data to one or more of first financial institution 120 and second financial institution 130 via network interface components. First financial institution 120 and second financial institution 130 may be provided by one or more cloud processing platforms, such as Amazon Web Services® (AWS) Cloud Computing Services, Google Cloud Platform®, Microsoft Azure® Cloud Platform, and the like, or may correspond to computing infrastructure of an entity, such as a financial institution.

Several elements in the system shown and described in FIG. 1 include elements that are explained briefly here. For example, the client devices could include a desktop personal computer, workstation, laptop, notepad computer, PDA, cell phone, or any wireless access protocol (WAP) enabled device or any other computing device capable of interfacing directly or indirectly to the Internet or other network connection. The client devices may also be a server or other online processing entity that provides functionalities and processing to other client devices or programs, such as online processing entities that provide services to a plurality of disparate clients.

The client devices may run an HTTP/HTTPS client, e.g., a browsing program, such as Microsoft's Internet Explorer or Edge browser, Mozilla's Firefox browser, Opera's browser, or a WAP-enabled browser in the case of a cell phone, tablet, notepad computer, PDA or other wireless device, or the like. According to one embodiment, the client devices and all of its components are configurable using applications, such as a browser, including computer code run using a central processing unit such as an Intel Pentium® processor or the like. However, the client devices may instead correspond to a server configured to communicate with one or more client programs or devices, similar to a server corresponding to fraud detection system 110 that provides one or more APIs for interaction with the client devices in order to submit data sets, select data sets, and perform modeling operations for an ML system configured for fraud detection.

Thus, fraud detection system 110, first financial institution 120, and/or second financial institution 130 (as well as any client devices) and all of their components might be operator configurable using application(s) including computer code to run using a central processing unit, which may include an Intel Pentium® processor or the like, and/or multiple processor units. A server for fraud detection system 110, first financial institution 120, and/or second financial institution 130 may correspond to Window®, Linux®, and the like operating system server that provides resources accessible from the server and may communicate with one or more separate user or client devices over a network. Exemplary types of servers may provide resources and handling for business applications and the like. In some embodiments, the server may also correspond to a cloud computing architecture where resources are spread over a large group of real and/or virtual systems. A computer program product embodiment includes a machine-readable storage medium (media) having instructions stored thereon/in which can be used to program a computer to perform any of the processes of the embodiments described herein utilizing one or more computing devices or servers.

Computer code for operating and configuring fraud detection system 110, first financial institution 120, and second financial institution 130 to intercommunicate and to process webpages, applications and other data and media content as described herein are preferably downloaded and stored on a hard disk, but the entire program code, or portions thereof, may also be stored in any other volatile or non-volatile memory medium or device, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

### Feature Ranking and Transfer Learning for ML Modeling

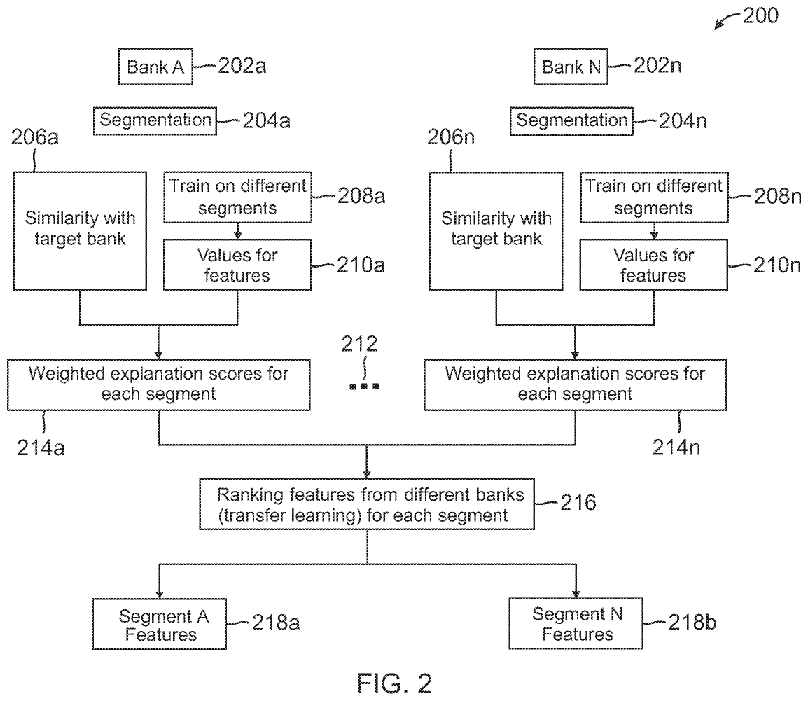

FIG. 2 is a simplified block diagram 200 of a transfer learning system that may perform feature selection between a selected and target financial institution according to some embodiments. Diagram 200 of FIG. 2 includes a bank A 202a and a bank N 202n that may each have separate transaction or other financial data sets, such as those data sets that may be provided by first financial institution 120 and/or second financial institution 130 discussed in reference to environment 100 of FIG. 1. In this regard, diagram 200 displays processes for feature ranking and transfer learning for ML models utilized by an AI system, such as fraud detection system 110 from environment 100. This may include operations for generation of an intelligent model for fraud detection in low fraud scenarios. Thus, the blocks in diagram 200 may be utilized to train a hybrid ML model using transfer learning for feature ranking and selection.

During segmentations 204a and 204n for bank A 202a and bank N 202n, respectively, a corresponding data set is accessed, retrieved, or received by an ML or other AI system for fraud detection in transaction data sets. In order to provide transfer learning, segregation and seclusion of the data sets between bank A 202a and bank N 202n may be required so that separate data sets are not combined, and the models with corresponding features may be learned from separate data sets and rankings of features. In this regard, each data set may correspond to one or more transaction data sets from one or more banks, financial entities or institutions, or the like. Bank N 202n may correspond to a different bank, financial entity, or the like from bank A 202a. Additionally, while each data set may correspond to a single data set (e.g., where one or more models may be trained), each data set may also include multiple different data sets for different segments and generation of further models.

For example, prior and/or during segmentations 204a through 204n for each financial institution corresponding to bank A 202a through bank N 202n, identification of a scenario for a low fraud bank and/or transaction data set may be performed. Prior to and/or during segmentations 204a through 204n, the operations of the service provider or other transfer learning system for fraud detection first identifies whether a tenant financial institution (e.g., bank A 202a and/or bank N 202n) qualifies as a low fraud scenario institution and/or training data set. This may be done by obtaining a training data set and performing data extraction. Data may be extracted over a specific time period and for a specific data channel, profiling, and/or detection purpose. For example, a segment of transaction data may include commercial international wire transfers occurring via an offline channel, which may correspond to a subset of transactional data used for training purposes. Multiple different types of segments may be determined for the transaction data set.

During segmentation 204a through 204n, features considered for model inclusion may be determined, such as those features available to an ML platform's decision processes at a time of execution (e.g., available to an ML model trainer and/or decision platform of a service provider). This may include a variety of features describing the transaction and/or the party initiating the transaction. Features for ML model training and/or processing may also include session information describing the connecting device and connection pathway, as well as the sequencing of the transaction in the current session. Filters may be used, which represent business rules that assist processing of transaction in an effective manner. A filter rule may evaluate an incoming transaction and determine if the transaction needs to be further evaluated by an ML model.

With low fraud scenarios and transaction data sets, fraud enrichment (data enrichment) may be performed. Data enrichment assists in gathering extra information based on a few data points in the training and/or testing data sets. With fraud enrichment for low fraud scenarios, extra fraud labels may be gathered from the available information present for fraud transactions by performing data enrichment to add fraud labels. This may be done by correcting some labels in the training data set where there is a reason to believe that the financial institution mistakenly tagged the transaction as legitimate instead of fraudulent. For example, in fraud detection and ML model training, the more fraud data available in the transaction data set, the more informed the training and decision-making may be when calculating risk and/or detecting fraud using ML models. Fraud enrichment may be performed based on an analysis of transactions that are in proximity to fraudulent transactions, in terms of business logic-based metrics, as well as assumptions that may be made based on the transaction data.

Prior to ML model training and testing, the transaction data set may then be split into a training data set and a testing data set. In low fraud scenarios, all of the fraudulent transactions and/or observations may be kept while sampling may be performed on the legitimate transactions and/or observations. A sampling step may be performed to ensure, with low occurrence of fraud, money laundering, noncompliance, etc. in transaction data sets, that sufficient fraudulent transactions are selected. This may be due to the unbalanced nature of large transaction data sets for banks and financial entities. There may be a significantly larger portion of the transaction data set for each of bank A 202a and bank N 202n for legitimate transactions, so sampling may be used to reduce data set bias due to uneven transaction and/or observation splitting. To reduce potential imbalance, sampling of the training, validation, and/or testing data sets may be conducted where all or a significant portion of the fraudulent transactions are kept with a small amount (e.g., a predefined threshold) of the valid transactions. During ML model training, a training data set is used to build the ML model, while a test data set is used to test and validate the model that is built. The data points in the training data set are excluded from those in the test data set, and vice versa, and the initial data set is divided into train and test data sets in order to check accuracies and precisions by the ML model. When splitting, a percentage (e.g., 80%) of the data set may be provided for training and another percentage (e.g., 20%) of the data set may be provided to testing. The data points in the training data set may chronologically occur before the data points in the test data set to avoid data leakage.

During segmentation 204a and 204n, the number of unique frauds per train and test set may be determined in order to determine whether the transaction data set and corresponding financial institution (e.g., bank A 202a and/or bank N 202n, respectively) qualifies as a low fraud scenario. For example, a specialized and/or unique API may be used to calculate the unique number of frauds per data set. For each financial institution or other tenant of the service provider and/or fraud detection system, the number of frauds may be determined and compared to a threshold number of frauds, which, when the number of frauds in below or at that threshold, causes the transaction data set and/or financial institution to qualify as a low fraud scenario. The threshold may be established for proper ML model training and testing and may be used to identify low fraud scenarios. Each fraud occurrence may be given a count of one irrespective of the number of frauds per party. The threshold may be predefined by domain experts based on the average count of frauds for a financial institution in a given time period. The unique frauds may be considered over a time period and, if that number meets or exceeds the threshold, the segment of the transaction data set for the financial institution may not be a low fraud scenario. However, all other data sets may be designated as low fraud scenarios for transfer learning of model features discussed herein.

Thus, for low fraud scenarios (as well as other ML operations), segmentation 204a and 204n may be used to segment tenant financial institutions based on their attributes and/or behaviors. Segmentation may therefore generate different business segments for different tenants. In order to perform model training, data pre-processing steps may be required. Data pre-processing may include steps of data cleaning, sampling, normalizing, determining intersecting columns between data sets, and feature engineering. Data cleaning may include removing columns which are characterized as zero-variance (meaning, have no more than one unique value), as those may not contribute to the model. During segmentations 204a and 204n, transactions performed via channels that are not relevant to the specific segment may be removed, other pre-processing based on the selected business segment may be performed, and further data cleaning operations may be performed. Further, features may be removed that have more than a predefined threshold of unique values. Normalizing may also occur where data sets are normalized to reduce their means and then scaled for each feature.

Model training may be performed from this data cleaning. Data cleaning identifies and corrects errors in the data set that may negatively impact model training and/or performance. Cleaning the data may further include removing null columns, correlated columns, duplicate rows, and the like, as well as filling missing values. Feature engineering may be performed by using domain knowledge to extract features from raw data in the training data set. For example, date features may be transformed into month, day, and/or hour features. Features may be based on business logic such as the first and last digits of each transaction amount. Categorical features may be encoded into frequency-based features based on one or more types of encoding, such as one-hot encoding, which reduces each categorical value to a separate Boolean variable based on whether the variable contains that value or not, lift-based encoding, where each category is assigned a numeric value based on its relative propensity to identify fraud, and/or population-based encoding, where each category is assigned a numeric value based on its relative frequency in the underlying population of values. However, a maximum number of features may be limited to avoid too many features and high dimensionality to encoding and/or embeddings from input feature data. During feature engineering, features may be identified and/or selected based on historically aggregated data for observations and/or transactions.

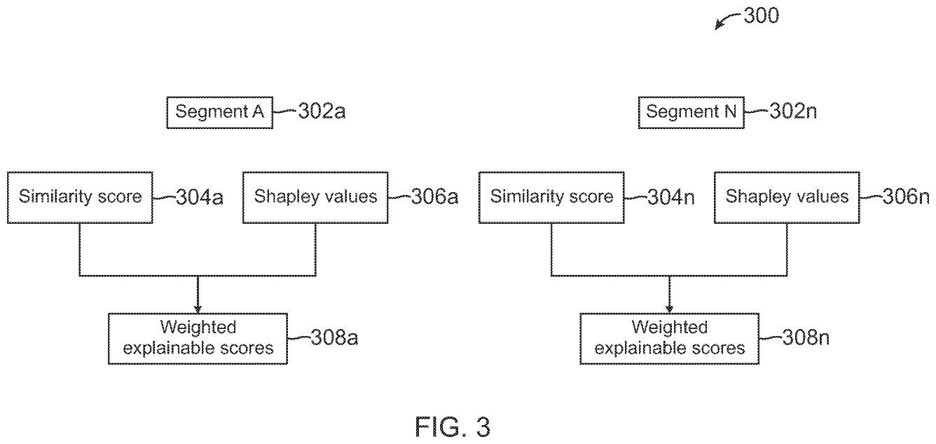

Similarities 206a and 206n may be determined for bank A 202a and bank N 202n, respectively, in order to weigh and adjust Shapley values generated for the transaction data sets and ML models and features trained on those transaction data sets. A cosine similarly between a selected financial institution (bank A 202a) and a target financial institution (bank N 202n) may be determined. Cosine similarity allows for comparison of a vector generated for bank A 202a and bank N 202n, as discussed in further detail with regard to FIG. 3. The comparison may be utilized to determine a weighted scoring of features for each model, and thereafter ranking the features of the ML models. After feature engineering, ML models are then trained on each segment for each source financial institution separately during a model training 208a and 208n for bank A 202a and bank N 202n, respectively. ML model training is a process in which an ML algorithm is provided sufficient training data for proper training and learning of output decision-making, classification, and/or prediction. Thus, ML training provides outputs based on the input training data. During supervised learning, an ML approach may use labeled datasets that identify fraudulent and non-fraudulent transactions. These datasets are designed to train algorithms into classifying data or predicting outcomes more accurately. Using labeled inputs and outputs, the model can measure its accuracy and learn over time. Unsupervised learning may use ML algorithms to analyze and cluster unlabeled data sets.

ML models may include different layers, such as an input layer, one or more hidden layers, and an output layer, each having one or more nodes, however, different layers may also be utilized. For example, ML models may include as many hidden layers between an input and output layer as necessary or appropriate. Nodes in each layer may be connected to nodes in an adjacent layer. In this example, ML models receive a set of input values or features and produce one or more output values, such as risk scores and/or fraud detection probability or prediction. However, different and/or more outputs may also be provided based on the training. When ML models are used to, each node in the input layer may correspond to a distinct attribute or input data type derived from the training data.

In some embodiments, each of the nodes in a hidden layer, when present, generates a representation, which may include a mathematical computation (or algorithm) that produces a value based on the input values of the input nodes. The mathematical computation may include assigning different weights to each of the data values received from the input nodes. The hidden layer nodes may include one or more different algorithms and/or different weights assigned to the input data and may therefore produce a different value based on the input values. The values generated by the hidden layer nodes may be used by the output layer node to produce an output value. When an ML model is used, a risk score or other fraud detection classification, score, or prediction may be output from the features. ML models trained during model training 208a and 208n may be separately trained using training data for each of bank A 202a and bank N 202n, respectively, where the nodes in the hidden layer may be trained (adjusted) such that an optimal output (e.g., a classification) is produced in the output layer based on the training data. By continuously providing different sets of training data and penalizing ML models when the output is incorrect, ML models (and specifically, the representations of the nodes in the hidden layer) may be trained (adjusted) to improve performance of the models in data classification. Adjusting ML models may include separately adjusting the weights associated with each node in the hidden layer.

After creation of the models, model explanation is performed to understand the importance of features in each model and the importance of the features to the models. Thus, after building the models, an ML model explainer, such as an explanation algorithm, may be used to verify the added value of each separate feature. This may include utilizing SHAP to obtain a measure of importance of each feature in each classification task, as discussed in further detail with regard to FIG. 3. SHAP is applied in order to provide explanation of the model for feature score values 210a and 210n for the models from model training 208a and 208n, respectively. Application of these processes in diagram 200 of FIG. 2 may occur for all analyzed banks 212, which may correspond to different tenants and financial institutions of a service provider or other fraud detection system.

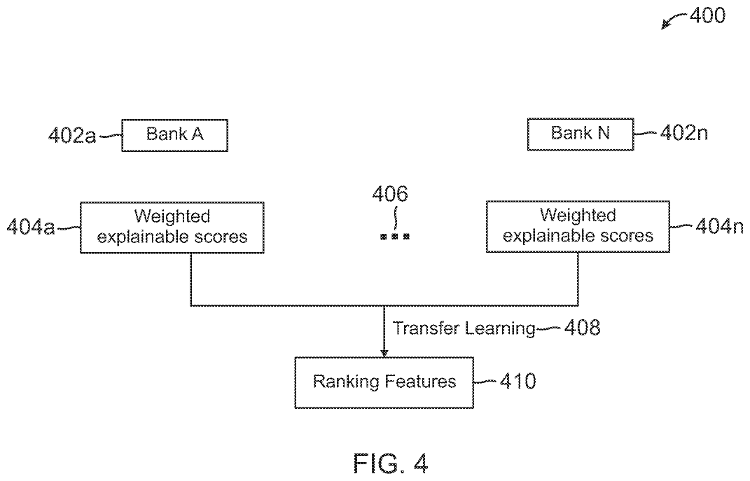

Output of feature score values 210a through 210n with similarities 206a through 206n for all analyzed banks 212 may then be used to obtain weighted explanation scores 214a through 214n. Weighted explanation scores 214a through 214n may then be used to provide a feature ranking 216 for all the features from the trained ML models of all analyzed banks 212. Weighted explanation scores 214a through 214n may correspond to Shapley values for features that may be weighted according to similarities 206a through 206n for each selected bank and corresponding target bank. Calculation and aggregation of weighted explanation scores 214a through 214n for ML model features is discussed in further detail with regard to FIG. 3. Feature ranking 216 may then be used to determine segment A features 218a and segment N features 218n for ML models for bank A 202a and bank N 202n, respectively, used for fraud detection in low fraud scenarios, as discussed in further detail with regard to FIG. 4 below.

FIG. 3 is a simplified diagram 300 of weighted explainable scores used for transfer learning according to some embodiments. In this regard, diagram 300 in FIG. 3 shows outputs of weighted scores for feature ranking 216 in diagram 200 of FIG. 2 based on feature data input for ML models. Diagram 300 includes a segment A 302a and a segment N 302n for segmented transaction data that may be provided by first financial institution 120 and/or second financial institution 130 discussed in reference to environment 100 of FIG. 1. In this regard, diagram 300 displays processes for feature ranking and transfer learning for ML models utilized by an AI system, such as fraud detection system 110 from environment 100, during generation of an intelligent model for fraud detection in low fraud scenarios.

After training and model explanation (e.g., calculation of Shapley values for features of each ML model), local interpretations from SHAP are converted to global interpretations so that feature contribution may be determined, which may vary from transaction to transaction and across different models and different transactions. Weighted explainable scores 308a and 308n for segment 302a and 302n, respectively, may be calculated for each using a profiling vector that may be generated for each financial institution's segment 302a and 302n, respectively. The profiling vector may be generated based on various information about the financial institution and/or the transaction data, such as mean transaction amount, variance, standard deviation, etc. Using the vectors and calculating a cosine similarity, similarity scores 304a and 304n may be generated between the two financial institutions for segment 302a and 302n, respectively. The target financial institution may correspond to one for which an ML model may be generated based on features selected from transfer learning.

Cosine similarity measures the similarity between two vectors using an inner product space of the vectors in n-dimensional space. For example, it may be measured by the cosine of the angle between two vectors, which indicates whether two vectors are pointing in the same direction. This may be a score between zero and one, where one indicates a high similarity between bank A 202a and bank N 202n, and where zero indicates no to little similarity. To calculate the cosine similarity score, a vector may be generated using the transaction data set for each respective bank or other financial institution (e.g., by encoding and/or embedding the data into a vector). This vector may correspond to a statistical profile vector for banks or other financial institutions and may further be based on model features selected by an explainable AI model (e.g., SHAP) and transfer learning of the features between target institutions and/or ML models. Further, the following equation may be used for cosine similarity determination, where A and B are the components of the vector for a first bank A and a second bank B:

$$cosine similarity = {S}_{C} ( A , B ) := cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} , \qquad Equation 1$$

In order to calculate Shapley values 306a and 306n for segment A 302a and segment N 302n, a SHAP algorithm is applied to the features for the ML models that have been selected and used to affect the output score, prediction, or classification. A SHAP algorithm may apply a game theory-based approach to explain the output of an ML model. SHAP is model agnostic and may be applied on supervised as well as unsupervised models. SHAP qualifies the contribution that each feature brings to the outcome classification or output by an ML model. Thus, SHAP quantifies the contribution that each feature brings to the prediction made by the model. This allows for generation of Shapley values 306a and 306n of each feature contributing to the output (e.g., the classification or prediction as fraudulent or non-fraudulent by an ML model) for each transaction using the SHAP algorithm. Features contribute to an ML model's output or prediction with different magnitude and sign, which is accounted for by Shapley values and scores. Accordingly, Shapley values 306a and 306n represent estimates of feature importance (magnitude of the contribution) as well as the direction as positive or negative (sign). Features with a positive sign contribute to the prediction of activity (e.g., fraudulent), whereas features with a negative sign contribute to the prediction of inactivity (i.e., negative contribution to activity prediction or non-fraudulent). An average of those contributions is determined to obtain a total significance level of each feature when ranking those features between different financial institutions.

Aggregated SHAP scores from Shapley values 306a and 306n, and/or other information, may be used to quantify and/or visualize the features of importance to ML models, and thereafter rank those features, as discussed with regard to FIG. 4. This may be necessary as model feature importance may vary between different data sets. For example, an IP address may be dynamic and therefore not as important a feature due to the inability to rely on a single number (e.g., IP addresses may change). The following equation may be used for Shapley value calculation:

$${φ}_{i} ( v ) = {\sum }_{S ⊆ N \backslash \{ i \}} \frac{\vert S \vert ! ( n - \vert S \vert - 1 ) !}{n !} ( v ( S ⋃ \{ i \} ) - v ( S ) ) \qquad Equation 2$$

By applying SHAP and determining Shapley values 306a and 306n with their corresponding one of similarity scores 304a and 304n, respectively, weighted explainable scores 308a and 308n for each of segment A 302a and segment N 302n between the two financial institutions may be calculated. This may then allow for transfer learning to be applied to determine features for ML model training and generation of fraud detection during low fraud count scenarios. Thus, the calculation of weighted explainable scores 308a and 308n may include two components—similarity scores 304a and 304n of each financial institution with the target financial institution and the Shapely values 306a and 306n of each feature for each of segment A 302a and segment N 302n of the financial institutions. These may be calculated by multiplying similarity scores 304a and 304n with Shapely values 306a and 306n. Thereafter, feature ranking from the different financial institutions may be performed for transfer learning.

FIG. 4 is a simplified diagram 400 of feature ranking in a transfer learning system according to some embodiments. In this regard, diagram 400 in FIG. 4 shows an output feature ranking 410 that may be performed for a bank A 402a and a bank N 402n. Diagram 400 includes bank A 402a and bank N 402n that may correspond to first financial institution 120 and/or second financial institution 130, respectively, discussed in reference to environment 100 of FIG. 1. In this regard, diagram 400 displays processes for feature ranking and transfer learning for ML models utilized by an AI system, such as fraud detection system 110 from environment 100, during generation of an intelligent model for fraud detection in low fraud scenarios.

Transfer learning 408 allows for stored knowledge while solving one problem (e.g., an ML model training and feature engineering/selection) to be applied to another problem (e.g., another ML model training and feature engineering/selection). This allows the labels for transactions between financial institutions to affect feature selection for ML models using feature ranking 410 of features from the Shapley values after calculating weighted explainable scores 404a and 404n using similarity scores between different financial institutions of bank A 402a and bank N 402n. Thus, weighted explainable scores 404a and 404n may be based on the components from diagram 300 of FIG. 3, such as by multiplying or otherwise calculating weighted score values. Comparisons 406 may be made for transfer learning 408 based on the different weighted scores for each financial institution. This then allows for obtaining feature ranking 410.

Once feature ranking 410 is obtained, an automated script may be run to perform forward feature selection from feature ranking 410. Forward selection may be an iterative method in which there is one feature in the ML model at the start of training. In each iteration, a feature is added from feature ranking 410, which is selected as best improving performance of the ML model until an addition of a new variable that does not further improve model performance. A customized forward feature selection class may run a logistic regression model and use DR and/or VDR metrics, which are specific to the financial domain. The forward selection may then determine a subset of features for the ML model for the target bank based on feature ranking 410. These features may identify fraud in a small number of daily alerts during low fraud scenarios and may therefore be used to create a hybrid ML model. Thereafter, ML models may be trained and/or generated using the forward selection of the features from feature ranking 410. Output of feature ranking 410 may be used to determine segment A features 218a and segment N features 218n from diagram 200 of FIG. 2.

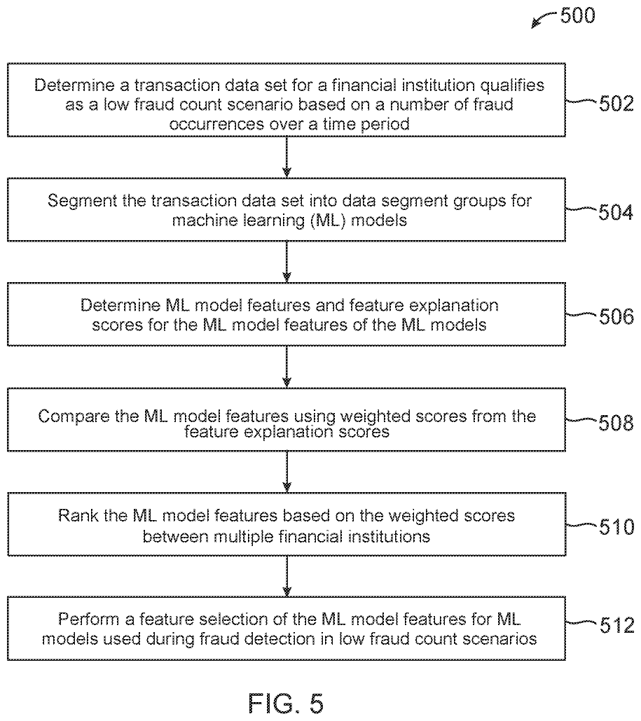

FIG. 5 is a simplified diagram of an exemplary flowchart 500 for a transfer learning system for feature selection in unsupervised machine learning models according to some embodiments. Note that one or more steps, processes, and methods described herein of flowchart 500 may be omitted, performed in a different sequence, or combined as desired or appropriate based on the guidance provided herein. Flowchart 500 of FIG. 5 includes operations for training an ML system for fraud detection, as discussed in reference to FIG. 1-4. One or more of steps 502-512 of flowchart 500 may be implemented, at least in part, in the form of executable code stored on non-transitory, tangible, machine-readable media that when run by one or more processors may cause the one or more processors to perform one or more of steps 502-512. In some embodiments, flowchart 500 can be performed by one or more computing devices discussed in environment 100 of FIG. 1.

At step 502 of flowchart 500, a transaction data set for a financial institution is determined to qualify as a low fraud count scenario based on a number of fraud occurrences over a time period. In order to determine that the financial institution and/or corresponding transaction data qualifies as a low fraud count scenario, a number of fraud counts may be determined after data cleaning, extracting, and/or enhancing (e.g., by adding additional fraud count tags). This may then be compared to a threshold, where if the number of the fraud counts does not meet or exceed a threshold number of frauds (e.g., is lower or at a number or count of frauds), then the transaction data set is a low fraud count scenario and lacks a sufficient fraud count. This determination may be used to determine that transfer learning used to perform feature selection for ML model training should be applied.

At step 504, the transaction data set is segmented into data segment groups for ML models. The transaction data set may be segmented in order to correlate transactions and/or other observations in the data set according to business segments, business rules, or the like. Segmentation may be used to train ML models based on specific business segments and/or fraud detection areas within a transaction data set. At step 506, ML model features and feature explanation scores are determined for the ML model features of the ML models. ML models may be trained based on the training and testing data sets from the segmented transaction data set. This initial ML model training may be done for each financial institution individually and may be done to train initial ML models that may be used for feature importance determination and ranking based on Shapley values from a SHAP algorithm processing of the ML model features.

At step 508, the ML model features are compared using weighted scores from the feature explanation scores. ML model features may be compared by calculating a cosine similarity or other similarity between different financial institutions, and thereafter using the similarity to weigh the explanation scores for each ML model feature between different financial institutions. This allows for weighted comparisons to be determined between different financial institutions based on their corresponding similarity. As such, financial institutions that may be considered more similar may have a corresponding higher weight in their respective scores for ML model features.

At step 510, the ML model features are ranked based on the weighted scored between multiple financial institutions. After applying a similarity score weight to each ML model feature's explanation score between different financial institutions, an overall aggregate weight for each feature may be determined. This weighted score then allows for ranking of the features according to their overall affect and/or importance in ML model outputs over multiple financial institutions, which allows for transfer learning of feature importance between different financial institutions. At step 512, a feature selection is performed of the ML model features for ML models used during fraud detection in low fraud count scenarios. This may be done using a forward feature selection process or operation, which iteratively proceeds through the ranked features and adds features unless the feature does not have a corresponding noticeable or detectable effect on ML model outputs. The results of the feature selection may then be used for ML model creation and training in low observation scenarios, such as when there are low fraud counts in transaction data sets for financial institutions.

As discussed above and further emphasized here, FIGS. 1, 2, 3, 4, and 5 are merely examples of fraud detection system 110 and corresponding methods for ML model feature selection and training using transfer learning, which examples should not be used to unduly limit the scope of the claims. One of ordinary skill in the art would recognize many variations, alternatives, and modifications.

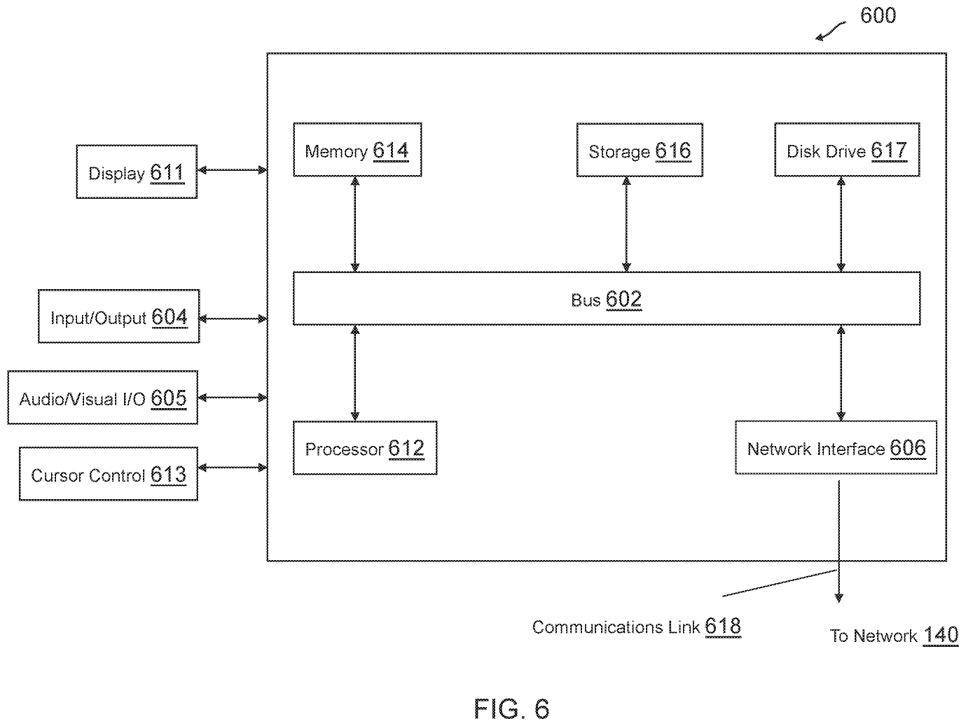

FIG. 6 is a block diagram of a computer system 600 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, image, or links, and/or moving one or more images, etc., and sends a corresponding signal to bus 602. I/O component 604 may also include an output component, such as a display 611 and a cursor control 613 (such as a keyboard, keypad, mouse, etc.). An optional audio/visual input/output component 605 may also be included to allow a user to use voice for inputting information by converting audio signals. Audio/visual I/O component 605 may allow the user to hear audio, and well as input and/or output video. A transceiver or network interface 606 transmits and receives signals between computer system 600 and other devices, such as another communication device, service device, or a service provider server via network 140. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the scope of the embodiments disclosed herein.

What is claimed is:

1. A machine learning (ML) system configured to detect fraud in tenant data systems, the ML system comprising:
a processor and a computer readable medium operably coupled thereto, the computer readable medium comprising a plurality of instructions stored in association therewith that are accessible to, and executable by, the processor, to perform ML modeling operations which comprise:
receiving a first data set for a first tenant data system usable for training a first machine learning model to detect fraud in the tenant data systems;
determining whether the first data set meets or exceeds a low fraud tenant threshold;
responsive to the determining, segmenting the first tenant data system into a tenant segment group based on the first data set;
determining first features of a first ML model based on at least a portion of the first data set and an ML model algorithm for the first ML model;
determining a first explanation of a first feature importance of each of the first features of the first ML model using an ML model explainer process;
comparing the first tenant data system to a second tenant data system based on at least the first explanation and a second explanation of a second feature importance of each of second features for the second tenant data system;
ranking at least the first features and the second features based on the comparing; and
performing a feature selection for at least one of the first ML model or a second ML model based on the ranking.

2. The ML system of claim 1, wherein the first explanation and the second explanation comprise SHapley Additive exPlanations (SHAP) values (Shapley values) generated from a SHAP algorithm.

3. The ML system of claim 2, wherein the determining the first explanation of the first feature importance of each of the first features comprises:
determining, using the first features from an overall set of features associated with the first ML model and the second ML model, a contribution of each of the Shapley values of the first features to the first ML model based on an average of the contribution of each of the Shapley values across the overall set of features.

4. The ML system of claim 1, wherein, before determining the first explanation of the first feature importance of each of the first features, the ML modeling operations further comprise:
converting the first explanation and the second explanation to a global explanation standard utilized with a plurality of ML models including the first ML model and the second ML model.

5. The ML system of claim 1, wherein determining that the first data set meets or exceeds the low fraud tenant threshold comprises:
determining a fraud count of transactional frauds in the first data set;
determining that the fraud count of the transactional frauds meets or exceeds the low fraud tenant threshold; and
determining that the first tenant data system is not associated with a low fraudulent financial institution based on the determining that the fraud count of the transactional frauds meets or exceeds the low fraud tenant threshold.

6. The ML system of claim 5, wherein, before determining that the first data set meets or exceeds the low fraud tenant threshold, the ML modeling operations further comprise:
performing at least one fraud enrichment operation on the first data set, wherein the at least one fraud enrichment operation causes one or more transactions in the first data set to convert from a non-fraudulent transaction to a fraudulent transaction.

7. The ML system of claim 1, wherein prior to determining the first features of the first ML model, the ML modeling operations further comprise:
determining a training data set and a testing data set for the first ML model based on the first data set, wherein the first data set is separate from a second data set associated with the second ML model;
training the first ML model using the training data set; and
testing the first ML model using the testing data set.

8. The ML system of claim 1, wherein comparing the first tenant data system to the second tenant data system utilizes a cosine similarity between at least two vectors generated between the first explanation and the second explanation.

9. A method to detect fraud in tenant data systems by a machine learning (ML) system, the method comprising:
receiving a first data set for a first tenant data system usable for training a first machine learning model to detect fraud in the tenant data systems;
determining whether the first data set meets or exceeds a low fraud tenant threshold;
responsive to the determining, segmenting the first tenant data system into a tenant segment group based on the first data set;
determining first features of a first ML model based on at least a portion of the first data set and an ML model algorithm for the first ML model;
determining a first explanation of a first feature importance of each of the first features of the first ML model using an ML model explainer process;
comparing the first tenant data system to a second tenant data system based on at least the first explanation and a second explanation of a second feature importance of each of second features for the second tenant data system;
ranking at least the first features and the second features based on the comparing; and
performing a feature selection for at least one of the first ML model or a second ML model based on the ranking.

10. The method of claim 9, wherein the first explanation and the second explanation comprise SHapley Additive exPlanations (SHAP) values (Shapley values) generated from a SHAP algorithm.

11. The method of claim 10, wherein determining the first explanation of the first feature importance of each of the first features comprises:
determining, using the first features from an overall set of features associated with the first ML model and the second ML model, a contribution of each of the Shapley values of the first features to the first ML model based on an average of the contribution of each of the Shapley values across the overall set of features.

12. The method of claim 9, wherein, before determining the first explanation of the first feature importance of each of the first features, the method further comprises:
converting the first explanation and the second explanation to a global explanation standard utilized with a plurality of ML models including the first ML model and the second ML model.

13. The method of claim 9, wherein determining that the first data set meets or exceeds the low fraud tenant threshold comprises:
determining a fraud count of transactional frauds in the first data set;
determining that the fraud count of the transactional frauds meets or exceeds the low fraud tenant threshold; and
determining that the first tenant data system is not associated with a low fraudulent financial institution based on the determining that the fraud count of the transactional frauds meets or exceeds the low fraud tenant threshold.

14. The method of claim 13, wherein, before determining that the first data set meets or exceeds the low fraud tenant threshold, the method further comprises:
performing at least one fraud enrichment operation on the first data set, wherein the at least one fraud enrichment operation causes one or more transactions in the first data set to convert from a non-fraudulent transaction to a fraudulent transaction.

15. The method of claim 9, wherein prior to determining the first features of the first ML model, the method further comprises:
determining a training data set and a testing data set for the first ML model based on the first data set, wherein the first data set is separate from a second data set associated with the second ML model;
training the first ML model using the training data set; and
testing the first ML model using the testing data set.

16. The method of claim 9, wherein comparing the first tenant data system to the second tenant data system utilizes a cosine similarity between at least two vectors generated between the first explanation and the second explanation.

17. A non-transitory computer-readable medium having stored thereon computer-readable instructions executable to detect fraud in tenant data systems using a machine learning (ML) system, the computer-readable instructions executable to perform ML modeling operations which comprises:
receiving a first data set for a first tenant data system usable for training a first machine learning model to detect fraud in the tenant data systems;
determining whether the first data set meets or exceeds a low fraud tenant threshold;
responsive to the determining, segmenting the first tenant data system into a tenant segment group based on the first data set;
determining first features of a first ML model based on at least a portion of the first data set and an ML model algorithm for the first ML model;
determining a first explanation of a first feature importance of each of the first features of the first ML model using an ML model explainer process;
comparing the first tenant data system to a second tenant data system based on at least the first explanation and a second explanation of a second feature importance of each of second features for the second tenant data system;
ranking at least the first features and the second features based on the comparing; and
performing a feature selection for at least one of the first ML model or a second ML model based on the ranking.

18. The non-transitory computer-readable medium of claim 17, wherein the first explanation and the second explanation comprise SHapley Additive exPlanations (SHAP) values (Shapley values) generated from a SHAP algorithm.

19. The non-transitory computer-readable medium of claim 18, wherein determining the first explanation of the first feature importance of each of the first features comprises:
determining, using the first features from an overall set of features associated with the first ML model and the second ML model, a contribution of each of the Shapley values of the first features to the first ML model based on an average of the contribution of each of the Shapley values across the overall set of features.

20. The non-transitory computer-readable medium of claim 17, wherein, before determining the first explanation of the first feature importance of each of the first features, the ML modeling operations further comprise:
converting the first explanation and the second explanation to a global explanation standard utilized with a plurality of ML models including the first ML model and the second ML model.
